(19) United States
(12) Patent Application Publication
(10) Pub. No.: US 2012/0023054 A1
(43) Pub. Date: Jan. 26, 2012

(54) Device and Method for Creating a Process Model

(75) Inventor: Michael Pirker, Munchen (DE)

(73) Assignee: Siemens Aktiengesellschaft, Muenchen (DE)

(21) Appl. No.: 13/262,476

(22) PCT Filed: Feb. 18, 2010
(86) PCT No.: PCT/EP2010/052069

§ 371 Date: Sep. 30, 2011

(30) Foreign Application Priority Data
Mar. 30, 2009 (DE) 1020090154973

(51) Int. Cl. G06N 5/02; G06F 17/00

(52) U.S. Cl. 706/46; 706/59

(57) ABSTRACT

A method and device for creating a process model, wherein the process model has great expressive power and is intuitively understandable for a human user and is processable by a machine. Creation of the process model is performed by providing a concrete process model, a process meta model, and a mapping of concrete process steps to abstract process steps of the process meta model. It is particularly advantageous that the defined process meta model can be reused in relation to further domain-specific, concrete process models. Accordingly, step-for-step instructions can be semantically enriched, structured, and processed.

### CROSS-REFERENCE TO RELATED APPLICATIONS

This is a U.S. national stage of application No. PCT/EP2010/052069 filed 18 Feb. 2010. Priority is claimed on German Application No. 10 2009 015 497.3 filed 30 Mar. 2009, the content of which is incorporated herein by reference in its entirety.

### BACKGROUND OF THE INVENTION

1. Field of the Invention

The present invention relates to a device configured to semantically enrich and structure existing process models, and a corresponding method. The invention further relates to a computer program product for performing the method and a data storage device which stores the computer program product.

2. Description of the Related Art

Technical apparatuses, such as production lines or production plants, typically comprise a plurality of components. With technical advances, such apparatuses are becoming increasingly complex from a technical perspective. This leads to many potential error functions of the apparatuses, whereby the maintenance thereof becomes more difficult. Typically, the causes of errors of such complex devices are no longer able to be identified immediately. Maintenance of complex devices is costly and may only be performed by technical personnel who are specialists. Corresponding specialist knowledge has to be maintained which involves a high outlay.

Maintaining technical devices often results in the replacement of individual components of the device. Thus the situation may arise where individual components of the device to be maintained are defective and/or functionally inoperational. It is also possible that individual components are functionally operational but already exhibit signs of wear. Frequently, the replacement of individual components is associated with a lower outlay and/or cost than repairing the components.

Both repair and replacement of components may be performed by using a specification of the corresponding apparatus as a guide. A substantial proportion of the descriptions for the assembly, start-up and use of technical apparatuses, installations, devices or software are step-by-step instructions which describe a suitable procedure to achieve a specific goal by the most efficient procedure possible. Such instructions are, for example, operating instructions, handbooks, process documentation or handling instructions.

In conventional procedures for technical apparatuses, specialist personnel perform maintenance steps that are read from, for example, a handbook, i.e., the specialist personnel always have to carry a handbook that require continuous updating. Typically, a separate handbook is provided for each technical apparatus. For updating a handbook, normally an expert in the field who has specialized in the field of maintenance as well as a further expert in the field who has specialized in the technical field of the documentation are used. As a result, in conventional methods, a plurality of specialists contribute to the maintenance process and to the creation of maintenance instructions.

Generally, individual handbooks are often provided in electronic form as part of the electronic operating instructions and user handbooks. With the electronic form of operating instructions and user handbooks, the preparation of step-by-step instructions is typically not provided for machine processing. Electronic operating instructions regularly have text and illustrations which are read and implemented by a maintenance technician. The ability to process step-by-step instructions is not possible in an automated manner and in terms of information technology, due to the absence of structuring of the operating instructions.

Moreover, representative forms of electronic step-by-step instructions, which are provided both for interactive use by the user and by software applications, are implemented by simple sequences of action steps that can be read by humans and are machine-readable. Partial information via step-by-step instructions is in this case typically created and managed in a simple or redundant manner in the respective software application. Additionally, the information for the user, usually as text and illustrations, may be processed separately therefrom.

In conventional methods, process descriptions are typically simply structured in a vague manner to make them intuitively understandable for a human user. Alternatively, processes are described using a complex structure and are only accessible by machine processing. As a result, it is not possible for process models used according to conventional methods to be created, maintained and/or implemented both by human users and by machines. Moreover, in conventional methods it is not possible to reuse individual parts of a process description which preferably are generically defined.

### SUMMARY OF THE INVENTION

It is therefore an object of the present invention to provide an improved method for creating semantically enriched and structured process models.

This and other objects and advantages are achieved in accordance with the invention by a device for creating a process model comprising a structure provision unit for providing a process structure description, where the process structure description specifies a structure of a generic process; a process description unit for providing a process description, where the process description specifies process steps and at least one temporal or causal dependency of the process steps; and where a relationship generating unit which for creating the process model generates at least one relationship between the process structure description and the process description that are provided.

The process model thus comprises a process structure description, a process description and a mapping of the features of the process description to features of the process structure description. A process structure description may also be regarded as a meta model, which describes a generic process. Typically, a process structure description models individual process steps and temporal dependencies between the individual process steps. A temporal dependency between individual process steps is, for example, that one process step is performed before or after a further process step. Temporal dependencies between process steps may generate an order to the process steps. Process steps may also be in causal dependency relative to one another. A causal dependency describes the situation where, for example, when a specific selection of process steps has been performed, a further selection of process steps may be performed.

The process structure description defines, for example, that a process has a plurality of phases, each phase being able to have any number of process steps. The process structure description may also be defined as a basic framework of a process which may be extended in any manner.

A generic process is, for example, a process which is defined on an abstract plane. A generic process is, for example, a start phase, any number of phases and/or an end phase. Such an abstract, generic process may be refined and/or specialized relative to any domains. Thus, for example, a start phase may be opening a document, a further phase may constitute processing of the document and an end phase may describe storing and closing a document.

A relationship between the process structure description provided and the process description provided may, for example, be modeled as an “is a” relationship. For example, in the process structure description an abstract step may be defined, which is present in the process description as a concrete step. Thus, a relationship between a feature of the process structure description and the process description may be generated. It is particularly advantageous, in this case, if for each concrete step of the process description an abstract step may be identified in the process structure description and/or assigned thereto. In this manner, step-by-step instructions may be structured and semantically enriched. The semantic enrichment occurs by an integration of the process description into the process structure description. This integration may be undertaken, for example, by producing at least one relationship between the process structure description provided and the process description provided.

The process model created comprises the process structure description, the process description and the relationships between the process structure description and the process description.

The process structure description provided may be present as a formal model, a Boolean model, a description logic model, a predicate logic model, a rule-based model, a specification, an ontology, a meta structure definition and/or a natural speech text. This has the advantage that the process descriptions and the process structure descriptions may be machine-read and automatically checked.

The process structure description may have a process, a phase, a process step, a start phase, an end phase, a preliminary phase, a terminal phase, a sequence of processes, a sequence of phases, a sequence of process steps and/or a step sequence. This has the advantage that the process structure description specifies a flexible meta model of a process.

A process has at least one phase. A phase comprises at least one process step. This has the advantage that a process may be represented with any granularity. Moreover, iterations and/or sequences on any sub-processes may be defined.

Process steps may be performed in parallel, alternately, optionally and/or iteratively. This provides the advantage that any sequences of process steps may be modeled.

Causal dependencies may be defined relative to a transitivity, a reflexivity and/or a symmetry. This has the advantage that, for example, transitive relationships for individual process steps may be defined. For example, it may be defined that when a dependency exists between a process step A and a process step B, as well as a process step B and a process step C, this dependency also applies between the process steps A and C.

This is advantageous, in particular, when modeling temporal relationships. Thus, for example, it may be defined that when a process step A occurs before a process step B, and a process step B occurs before a process step C, the process step A may also be performed transitively before the process step C.

The provision of the process description in one possible embodiment depends on the read-out from a sensor. This has the advantage that user inputs may be monitored by a sensor and a process description may be created therefrom. The read-out of the sensor occurs, for example, for analyzing a screen shot. In this case, a user performs a plurality of process steps on a computer system, where the individual process steps are identified using a plurality of screenshots.

The provision of the process description may depend on operating instructions, a user handbook, process documentation and/or a user input. This has the advantage that documentation which already exists may be reused for providing the process description.

The provision of the process structure description and/or the process description may occur by a read-out from a data storage device. This provides the advantage that already existing process structure descriptions and/or already existing process descriptions may be reused. Thus, it is possible, for example, to use a process structure description in different domains.

The device for creating a process model in one possible embodiment has a reasoning unit that is capable of monitoring the consistency of the process structure description. This has the advantage that the process structure description is fault-free and thus may be reused in any number of domain-specific process descriptions.

A reasoning unit is capable of extracting implicit knowledge from an existing knowledge base. A reasoning unit is also capable of generating new knowledge by inference from an existing knowledge base.

The invention further relates to a method for creating a process model, in particular by using the already described devices and has the steps of providing a process structure description, where the process structure description specifies a structure of a generic process; providing a process description, where the process description specifies process steps and at least one temporal or causal dependency of the process steps; and generating at least one relationship between the process structure description provided and the process description provided for creating the process model.

The invention further relates to a computer program product for carrying out the disclosed method.

The invention further relates to a data storage device which stores the computer program product.

The invention thus provides a method and device which make it possible to create a process model that semantically enriches and structures processes. The process model created is intuitively understandable for a human user, in spite of extensive expressive power, and due to the use of any representative forms, such as a formal model, is also machine-readable. Moreover, the proposed method and the device permit the process structure description to be able to be defined independently of the specific process description and thus may be reused relative to further domain-specific process descriptions.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in more detail hereinafter with reference to exemplary embodiments, by referring to the accompanying figures, in which:

FIG. 1 shows a structured process model as may be created in accordance with the present invention;

FIG. 2 shows a hierarchical division of step-by-step instructions in accordance with an embodiment of the present invention;

FIG. 3 shows a block diagram of a device configured to create a process model in accordance with an embodiment of the present invention;

FIG. 4 shows a detailed block diagram for representing an of a device configured to create a process model in accordance with an embodiment of the present invention;

FIG. 5 shows a flow diagram for representing an embodiment of the method in accordance with the invention for creating a process model; and

FIG. 6 shows a detailed flow diagram for representing an embodiment of the method in accordance with the invention for creating a process model.

### DETAILED DESCRIPTION OF THE PREFERRED EMBODIMENTS

Elements which are the same and/or functionally that is the same have been assigned the same reference numerals in the figures, provided there are no differences.

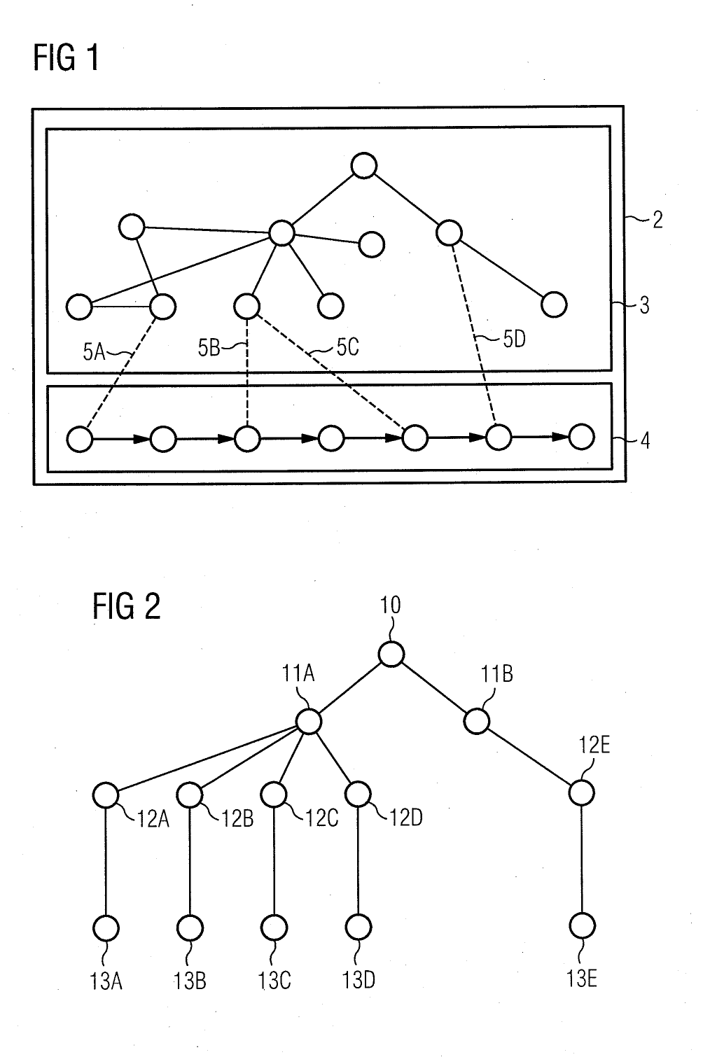

FIG. 1 shows a created process model 2 in accordance with an embodiment of the present invention. The process model 2 comprises a process structure description 3, a process description 4, as well as relationships 5A, 5B, 5C, 5D which have been generated.

In the present exemplary embodiment, the process structure description 3 is defined by description logic modeling approaches. In this case, for example, OWL-DL may be used. Alternatively or in combination with OWL-DL, further OWL-DL variants, DAML+OIL or RDFS may also be used. Here, it is particularly advantageous that the process structure description 3 is implemented as a formal model. As a result, further Boolean logic, description logic, predicate logic and/or rule-based models are capable of defining the process structure description 3.

In the present exemplary embodiment, the definition of the process structure description 3 takes place by the description logic concepts and relationships of the OWL-DL. In this case, an ontological concept comprises a process, a phase and/or a step, this being illustrated in FIG. 1 as circles. The defined and logic concepts are placed in relative pairs by defining ontological relationships. As a result, it is possible to associate individual steps with individual phases. The relationships are shown in the present FIG. 1 by lines, which connect the circles that represent concepts. A relationship may thus also be defined reflexively, i.e., one step may in turn comprise further steps. The ontological relationship may also be defined between a plurality of concepts. For example, groups of process steps may be defined. Ontological relationships may also be used for implementing sequences of phases within step-by-step instructions. Here, it is possible to define in the process structure description 3 that specific phases form a sequence in a specific order.

The ontological concepts defined in the process structure description 3 may also have further attributes. For example, a process step, which is modeled as an ontological concept, has a descriptive text. A descriptive text in this case provides information about how the corresponding process step is to be performed.

In the present exemplary embodiment, the process structure description 3 defines that a meta model following a generic process comprises:

The generic process consists of one or more phases. One phase encapsulates one or more possible steps. A step is an action to be performed by humans or machines. Phases are arranged in sequence, for example, preliminary or follow-up phases. In other words, by phases, sequences of sets of steps are predetermined. Steps in one phase are not ordered in sequences, i.e., one or more steps of a phase may be implemented in any sequence. Not every step in one phase necessarily has to be performed. The same step within a phase may be performed occasionally or the same step may be performed just once in a phase, but at least one step of a phase has to be performed to activate the follow-up phase.

The generic process begins with a start phase. The start phase is an exceptional phase which does not have a preliminary phase. The generic process ends with a terminal phase. The terminal phase is an exceptional phase that does not have a follow-up phase.

The generic process may have parallel sequences, which have at least one of the following features:
each phase apart from the start phase has at least one preliminary phase;
each phase apart from the end phase has at least one follow-up phase;
each phase apart from the start phase may have a plurality of preliminary phases;
each phase apart from the end phase may have a plurality of follow-up phases; and/or
by parallel phase sequences, phases may be made optional, for example, the phase sequence phase P1->phase P2->phase P3 may be extended by a parallel phase sequence phase P1->phase P3, and as a result phase P2 is optional.

The process model 2 shown in FIG. 1 further comprises a process description 4. The process description 4 may, in this case, comprise a plurality of process steps, where the process descriptions are in a temporal and/or causal dependency with one another. Typically, processes are defined as a sequence of individual process steps. In the present exemplary embodiment, the process description 4 describes step-by-step instructions. The step-by-step instructions are in an electronic format, which permits individual process steps of the step-by-step instructions to be identified. Moreover, it may be possible in the step-by-step instructions to identify individual phases. Thus, for example, a chapter of a handbook, which has step-by-step instructions, and a chapter for a phase may be predefined and a sub-chapter and/or a paragraph for a step may be provided. Using these features, the process steps of the process description 4 are mapped in steps that are defined in the process structure description 3. Similarly, phases may be identified in the process description 4.

Relationships 5A, 5B, 5C, 5D between the process steps of the process description 4 and the phases and/or steps modeled in the process structure description 3 may thus be generated using the identified mapping of features of the process structure description 3 and the features of the process description 4. In this case, the steps and/or the phases of the process description 4 instantiate the steps and/or the phases of the process structure description 3.

Due to the defined process structure description 3 the instantiated process steps of the process description 4 in the present exemplary embodiment may be performed according to at least one of the following options:
implementation of parallel steps based on parallel phase sequences;
implementation of alternative steps based on parallel phase sequences and/or based on optional definition of the execution semantics of the step;
implementation by utilizing transitive relationships, based on parallel phase sequences, which permit a phase to be skipped; and/or
implementation by optional steps, in the event that in the process structure description 3 it is defined that not every step has to be performed.

The process structure description 3 may comprise further elements which, for example, provide the model that phase sequences may be performed repeatedly within step-by-step instructions, or a hierarchical division of step-by-step instructions may be defined. Here, step-by-step instructions may be arranged in a modular manner for complex step-by-step instructions.

FIG. 2 describes a hierarchical sub-division of a process in accordance with an embodiment of the present invention.

In the present exemplary embodiment, a process 10 which represents a maintenance process of a machine, in accordance with the presently contemplated embodiment of the invention, is structured and semantically enriched. To this end, a process structure description 4 is provided. The process structure description comprises the process 10, as well as the phases 11A and 11B. The phase 11A in the present exemplary embodiment is subdivided into the process steps 12A, 12B, 12C and 12D. Moreover, it is defined in the process structure description 3 that the phase 11B has a process step 12E.

Using an already existing user handbook, in the present exemplary embodiment, it may be identified that for the maintenance of the machine the process step 13A “start-up of the machine”, the process step 13B “parameter read-out”, the process step 13C “unscrew housing”, the process step 13D “replace module”, as well as the process step 13E “function test” are to be performed.

In the present exemplary embodiment, it is identified from the user handbook that the process steps 13A, 13B, 13C and 13D are described in one chapter of the user handbook. As a result, each of the process steps 13A, 13B, 13C and 13D may be associated with an abstract process step 12A, 12B, 12C and 12D, which are included in phase 11A. As a result, the flat process structure consisting of the process steps 13A, 13B, 13C and 13D is semantically enriched and associated with a phase 11A that is incorporated in the process 10.

Moreover, it is identified in the example that the process step 13E “function test” is described in a different chapter of the user handbook, from the process steps 13A, 13B, 13C and 13D already described. As a result, it is possible to associate the process step 13E with a separate abstract process step 12E which, in turn, is contained in the phase 11B.

The tree structure shown in FIG. 2 is intuitively understandable both for a human user and accessible for machine processing.

In the present exemplary embodiment, the process steps 13A, 13B, 13C, 13D and 13E are identified using a rule-based identification method. A corresponding rule base may, for example, be defined in a descriptive language, such as SWRL. To this end, in the rule base it may be defined how an association of the concrete steps 13A, 13B, 13C, 13D to the abstract steps 12A, 12B, 12C, 12D and 12E has to occur. For example, it may be defined that individual steps that are described in one chapter of a user handbook, may be modeled in just one phase. Moreover, the rule base may be analyzed by a rule machine and/or a reasoning unit, further features of the process structure description 4 being able to be considered.

A process may also be defined as a sequence of states. A process may, as a result, be defined as a sequence of state transitions. In this case, the process structure description 3 thus refers to a state machine.

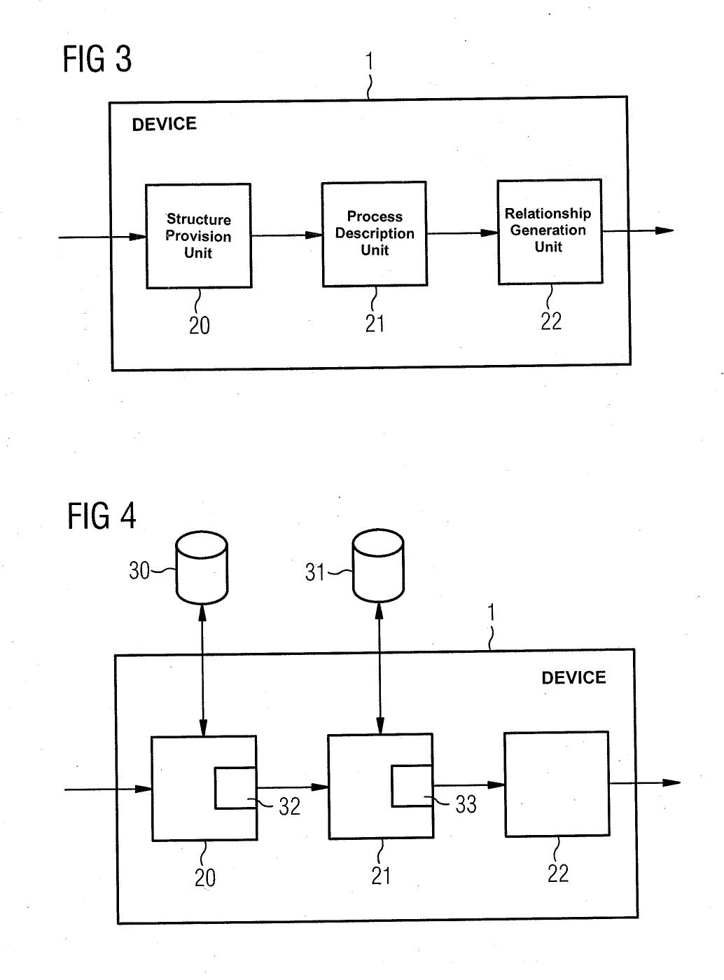

FIG. 3 shows a block diagram of a device 1 for creating a process model 2 in accordance with an embodiment of the present invention. The device 1 comprises a structure provision unit 20 for providing a process structure description 3, where the process structure description 3 specifies a structure of a generic process; a process description unit 21 for providing a process description 4, where the process description 4 specifies process steps and at least one temporal or causal dependency of the process steps; and a relationship generating unit 22, which for creating the process model 2 generates at least one relationship 5A, 5B, 5C, 5D between the process structure description 3 and the process description 4 that are provided.

FIG. 4 shows a detailed block diagram of a device 1 for creating a process model 2 in accordance with an embodiment of the present invention and differs from the device 1 shown in FIG. 3 as follows:

In the present exemplary embodiment, the structure provision unit 20 comprises a reasoning unit 32. The reasoning unit 32 is configured to verify a process structure description 3 for errors and/or consistency. The process structure description 3 may be read by the structure provision unit 20 from a data storage device 30. This may occur by, for example, a network. The process structure description 3 is present, for example, as a formal model that may be checked by rules that are also stored in the data storage device 30.

The process description unit 21 has in the present exemplary embodiment a sensor 33 which is capable of detecting the process description 30. Using predefined rules which, for example, are stored in the data storage device 31, the process description unit 21 may create a process description 4, depending on a sensor result. A sensor may, for example, be an image recognition sensor which analyzes handling instructions which have a plurality of graphic images. For example, a handbook that is already present has a plurality of graphic images of process steps, where the process steps are provided with text in each case. The visual sensor 33 is capable of reading the text from the respective graphic image and assigning the text, which has been read, to individual process steps. The process description unit 21 is able to read out from the data storage device 31 appropriate techniques that are required, in particular, for image processing.

The process structure description 3 and the process description 4 that are provided are transmitted to the relationship generating unit 22. The relationship generating unit 22 may have a data storage device, which provides rules describing how a relationship is created between the process structure description 3 and the process description 4.

The disclosed details of the device 1, in particular the structure provision unit 20, the process description unit 21, the relationship generating unit 22 as well as the reasoning unit 32 may be implemented as a processor, a micro-processor, a computer, a computer system, a central processing unit, an arithmetic calculating unit and/or as a circuit.

The data storage devices 30 and 31 may be formed by any type of storage medium, for example as a hard disk, flash disk, USB stick, floppy disk, diskette, CD, DVD, Blu-ray disk, magnetic tape, tape and/or as removable data carriers. The data storage devices 30 and 31 may also be implemented as a data bank server.

The data storage devices 30 and 31 in one possible embodiment are read over a network. A network in this case comprises at least one hub, a switch, a router, a server, an access point, a client, a transmitter, a receiver, a network card and/or further typical network components.

FIG. 5 discloses a flow diagram of a method for creating a process model 2, in particular by using a device 1 and comprises the following steps:
the provision 100 of a process structure description 3, the process structure description 3 describing and/or specifying a structure of a generic process;
the provision 101 of a process description 4, the process description 4 describing and/or specifying process steps and at least one temporal or causal dependency of the process steps; and
the generation 102 of at least one relationship between the process structure description 3 provided and the process description 4 provided, for creating the process model 2.

The described method steps may be performed iteratively and/or in a different sequence.

In a further exemplary embodiment, a system administrator executes a software installation process. To this end, the system administrator executes an installation program. The installation program guides the system administrator through the installation process by a sequence of virtual windows that are displayed on a screen. The process description unit 21 detects the individual process steps by screenshots, and provides the individual steps with text as window titles, which are displayed on each virtual window.

In the present exemplary embodiment, the title of a first virtual window reads “select components for installation” and a second window reads “indicate installation path”. The structure provision unit 20 provides a process meta model which describes that repeated process steps are always combined in phases. As the system administrator frequently performs the process steps “select components for installation” and “indicate installation path”, the reasoning unit 32 identifies that the two process steps are one phase which may be performed iteratively.

Thus a process model 2 is provided which represents both the installation process and a process description 4, and also provides a process structure description 3.

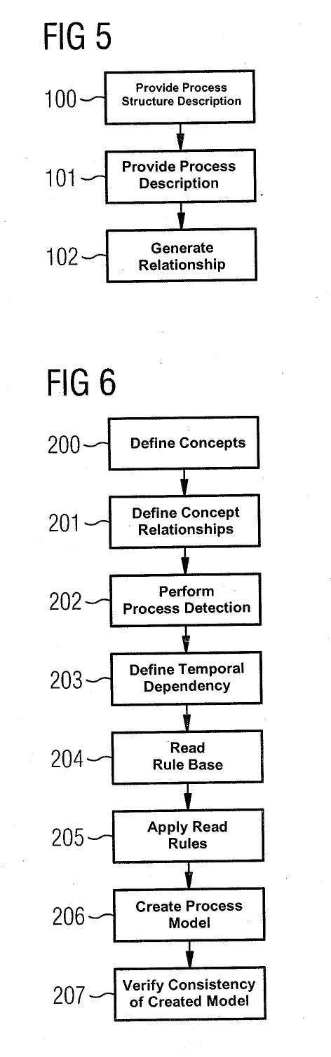

FIG. 6 shows a detailed flow diagram of a method for creating a process model 2 and has the following method steps:

In a first method step 200 concepts are defined which represent at least one process, at least one phase and/or at least one step. Concepts are in this case, for example, the phases 11A and 11B or the process steps 12A, 12B, 12C and 12D. Optionally, in the method step 200 further attributes are defined which are associated with the respective concept. Thus, for example, a specific descriptive text may be associated with a concept.

In a subsequent method step 201 a definition takes place of relationships to the concepts described in the method step 200. It is defined, for example, that a phase has a specific number of steps, and that specific steps have to be performed with each implementation of the phase and/or that specific steps are optionally performed. Moreover, in the method step 201 it may be defined which steps are able to run in parallel. Additionally, it may be described when specific phases have to be performed cyclically and/or when cycles have to be avoided.

In a subsequent method step 202 an automatic detection of process steps takes place. This may be performed, for example, by detecting screenshots. In this case, screenshots are created at regular intervals, whilst a specific process is performed. Using the screenshots, individual process steps may subsequently be identified. This may occur, for example, depending on the detection of text on elements that are displayed on a monitor when implementing a process. When implementing the process, for example, a plurality of virtual windows of an operating system, which comprise text, are opened. As a result, in the method step 202 it may be identified when a new virtual window is opened and/or a new process step is implemented.

In a method step 203 a temporal dependency is defined between the process steps detected in the method step 202. This may be performed, for example, by an analysis of the sequence of the virtual windows that are open. Here, for example, specific sequences may be identified which lead to the conclusion that, at a specific point when implementing the process, cycles occur and/or that individual process steps are performed iteratively.

In a subsequent method step 204 a rule base is read describes when relationships are present between the concepts defined in the method step 200 and the process steps detected in the method step 202.

In a subsequent method step 205 the rules read in the method step 204 are applied to the features defined in the method steps 200 to 203. Thus, an analysis is made of the process model 4 created, as well as the process structure description 3. When identifying corresponding relationships, the relationships are created in a subsequent method step 206.

By performing the method steps 200 to 206, a process model 2 is created which models and correspondingly documents a process with semantic information.

In a further optional method step 207 the consistency of the created model is verified, for example, by the reasoning unit 32.

The disclosed method steps may be performed iteratively and/or in a different sequence.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-13. (canceled)

14. A device for creating a process model, comprising:
a structure provision unit configured to provide a process structure description specifying a structure of a generic process;
a process description unit configured to provide a process description specifying process steps and at least one temporal or causal dependency of the specified process steps; and
a relationship generating unit configured to generate at least one relationship between the provided process structure description provided and the process description to create the process model.

15. The device as claimed in claim 14, wherein the process structure description provided by the structure provision unit comprises at least one of a formal model, a Boolean model, a description logic model, a predicate logic model, a rule-based model, a specification, an ontology, a meta structure definition and natural speech text.

16. The device as claimed in claim 14, wherein the process structure description includes at least one of a process, a phase, a process step, a start phase, an end phase, a preliminary phase, a terminal phase, a sequence of processes, a sequence of phases, a sequence of process steps and a step sequence.

17. The device as claimed in claim 15, wherein the process structure description includes at least one of a process, a phase, a process step, a start phase, an end phase, a preliminary phase, a terminal phase, a sequence of processes, a sequence of phases, a sequence of process steps and a step sequence.

18. The device as claimed in claim 16, wherein the process includes at least one of at least one phase and a phase having at least one process step.

19. The device as claimed in claim 14, wherein the process structure description specifies that the process steps is performable at least one of in parallel, alternately, optionally and iteratively.

20. The device as claimed in claim 14, wherein the causal dependency of the specified process steps is relative to at least one of a transitivity, a reflexivity and a symmetry.

21. The device as claimed in claim 14, wherein the provision of the process description depends on a read-out from a sensor.

22. The device as claimed in claim 14, wherein the provision of the process description depends on at least one of operating instructions, a user handbook, process documentation and a user input.

23. The device as claimed in claim 14, wherein the provision of at least one of the process structure description and the process description depends on a read-out of a data storage device.

24. The device as claimed in claim 14, further comprising:
a reasoning unit configured to monitor a consistency of the process structure description.

25. A method for creating a process model using a device having a structure provision unit, a process description unit and a relationship generating unit, the method comprising:
providing, by the structure provision unit of the device, a process structure description providing a structure of a generic process;
providing, by the process description unit of the device, a process description providing process steps and at least one temporal or causal dependency of process steps; and
generating, by the relationship generating unit of the device, at least one relationship between the process structure description provided and the process description (4 to create the process model.

26. A computer program executing on a processor which, when used on a computer apparatus, causes the processor to create a process model using a device having a structure provision unit, a process description unit and a relationship generating unit, the computer program comprising:
program code for providing, by the structure provision unit of the device, a process structure description providing a structure of a generic process;
program code for providing, by the process description unit of the device, a process description providing process steps and at least one temporal or causal dependency of process steps; and
program code for generating, by the relationship generating unit of the device, at least one relationship between the process structure description provided and the process description to create the process model.

27. A non-transitory data storage device encoded with a computer program executed by a computer that causes creation of a process model using a device having a structure provision unit, a process description unit and a relationship generating unit, the computer program comprising:
program code for providing, by the structure provision unit of the device, a process structure description providing a structure of a generic process;
program code for providing, by the process description unit of the device, a process description providing process steps and at least one temporal or causal dependency of process steps; and
program code for generating, by the relationship generating unit of the device, at least one relationship between the process structure description provided and the process description to create the process model.
